(19) United States
(12) Patent Application Publication
(10) Pub. No.: US 2008/0063491 A1
(43) Pub. Date: Mar. 13, 2008

(54) Snap staples

(76) Inventor: Edward Arthur Ringl JR., Temple, GA (US)

Correspondence Address: EDWARD ARTHUR RINGL JR., 865 Rainey Rd, Temple, GA, 30179, US

(21) Appl. No.: 11/806,536

(22) Filed: Jul. 28, 2004

(51) Int. Cl. F16B 15/00

(52) U.S. Cl. 411/476

(57) ABSTRACT

The Snap Staple is a change from the standard staple used today by having weakened areas in which to cause a break. The weakened area can be made by a groove, nick, cut, thinning of material, stretching of the material, or installing a different material into a part of the staple making a weakened area.

### BACKGROUND OF INVENTION

Staples are used to semi-permanent attach two or more items together. Either by bending legs of staples to pinch items together or binding items together without bending the legs as in tacking or nailing the items.

Staples are commonly used to apply two or more items together as paper but also used to keep skirting on tables, products to a wall, holding lumber together, and things of this nature. When it is necessary to separate the stapled items, this can be a laboring task and at times ruins the items being separated. The Snap Staple would break at the appropriate place making the items reusable and less labor intensive.

### SUMMARY OF THE INVENTION

The Snap Staple is a staple that would take less labor to reuse items than the conventional way that is used today. Some items stapled are not reused because of the labor it takes to make them reusable. The Snap Staple could eliminate this waste and make the items more economic to reuse and safer.

1. The labor savings that is associated with the Snap Staple as compared to the conventional staples used today. In some fields of the market a staple is not a permanent part of the operation of the business, but a temporary one. The need to reuse the item(s) over and over without harming either item and making items safer to use and reuse.

2. The cost in the products associated with staples, because of the more options for use. Also giving more choices and better performance, making for a larger market.

3. As in most staples and stapling the removal is done with a tool. The Snap Staple is made to secure the items and separate them again by using a force of some kind. By pulling items apart by hand, using a tool to separate item(s), or by pushing on one or more of the items to separate at appropriate area of staple.

In summary, there is provided a staple that is breakable upon pulling the items apart. Making each item reusable over and over. With a nick, cut, stretched, or different material in the lags or crown or bight of the staple.

The Invention consists of certain novel features and a combination of parts. It being understood that various changes in details made may be made without departing from the spirit or sacrificing any of the advantages of the invention.

### BRIEF DESCRIPTION OF THE DRAWINGS

For the purpose of a better understanding of the invention there is illustrated drawings followed by a preferred embodiments of the invention thereof. The appreciation of said invention should be obvious, along with its advantages in operation and construction. For the purpose of repetitiveness the “nick” mentioned in the figure drawings will also pertain to a cut, groove, thinned, stretched, or different material used to accomplish the same weakened area for the purpose of breaking.
Legend—A=“nick”
   B=Break
   C=Staple
   D=Table with skirting
   E=Boards/Wood/any Items

FIG. 1 is an overall view of the staple with nicks; these nicks can be cuts, grooves, thinning of material, or a different material all together. Any of the above can and will achieve the desired results.

FIG. 2 is a frontal view of the staple with the “nicks”.

FIG. 3 is a side view of the staple with “nicks”.

FIG. 4 is a top view of the staple with ghost lines showing the “nicks” and the staple leg.

FIG. 5 is an enlarged view of the “nick”.

FIG. 6 is an enlarged side view of the “nick”.

FIG. 7 is an overall enlarged view of the “nick” and staple.

FIG. 8 is an enlarged frontal view of the staple with a break at the “nick”.

FIG. 9 is an enlarged side view of the staple with a break at the “nick”.

FIG. 10 is a view of a typical table with skirting, being shown with the snap staple holding the skirting to the table.

FIG. 11 is an enlarged view of the skirting and the table, skirting being held on by the staple. The crown or bight of the staple is on the outside portion of the skirt. The “A” depicts the “nick” in the staple.

FIG. 12 is an enlarged view of the staple breaking when force is applied to the skirting or table.

FIG. 13 is an enlarged frontal view of two pieces of boards stapled together.

FIG. 14 is an enlarged side view of two pieces of boards stapled together.

FIG. 15 is an enlarged side view of the breaking of the staple when force is applied to either board.

### DESCRIPTION OF PREFERRED EMBODIMENTS

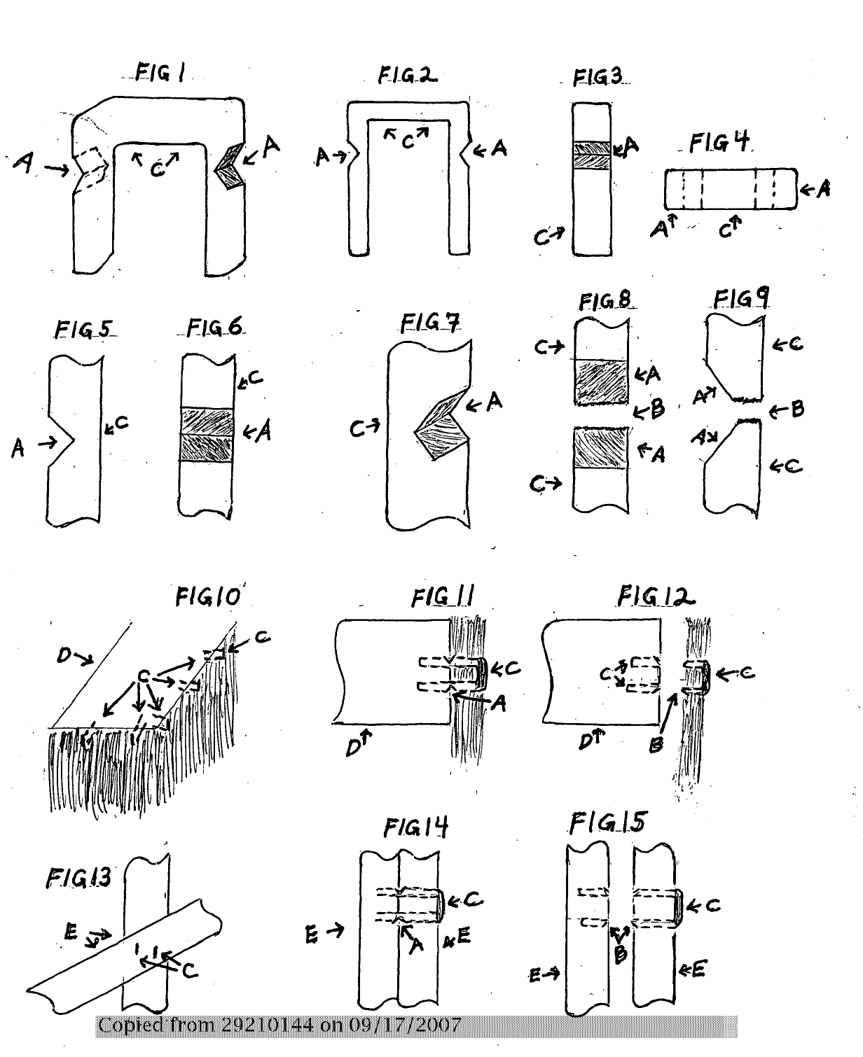

Referring to FIG. 1 there is a “nick”—A in the staple—C for the purpose of causing the staple to break at a desired point(s). This/These point(s) may vary with the need of the user. The weakening of the staple in a desired position for the breaking is the feature of the Snap Staple.

When the desire for the items stapled needs to be separated, a force is applied to one or both of the items. A force consisting of pulling, pushing, prying, or the use of a tool to hit, pry, push, or pull the two items apart. In doing so the staple is to break at the position in which the “nicks” are placed. In doing so the staple then is embedded in to an item or falls out leaving both items ready to use again. FIG. 12 and FIG. 15. This method also is a safer method than used today, because it doesn't leave a major portion of the staple exposed as in conventional staples today.

The Snap Staple would not have to be of any custom size or shape to work. The devices that are used to insert the staple in an item(s) could be used to for the Snap Staple. The “nick”, cut, groove, thinning of material, or the use of a different material to cause a weakening of the staple at a desired position could be created without the need of a “special device” to make the staple perform. Even though a device to make the staple perform the same can be accomplished but not necessarily needed. A device causing the staple to have a “nick” along any part or portion of the staple still has the same concept of the Snap Staple.

The “nick” could be placed in any position along the staple at any point.

What has been descripting above is an improved staple that is made to break at a desired area.

### SPECIFICATIONS

The invention that I am presenting is called the Snap Staple. It is unique in design and in utility for several reasons. In the design area, the staple is weakened for the purpose of being able to break in a specified area with little effort. This can accomplished several different ways, (a) Making all or part of the staple out of a breakable material. (b) Making staple with a nick, groove, cut, thinning, or other method of making the staple break in a specified location.

The utility is unique because the snap staple will be used when item(s) being stapled are for temporary use.

This invention would be less harmful to the item(s) it is used on. The Snap Staple would break with less force, and make the item(s) reusable several times.

1. A staple that is made to break apart when force is applied to the items stapled by pulling by hand or using an instrument/tool to force items apart.
A staple is comprised of two legs with a crown or bight.
A weakened area or areas on the legs or crown either by nicks, cuts, grooves, stretching the material, or adding a different material to weaken the staple.
The break in the staple is subject to change on the basis of need. The nick, groove, cut, stretching, or adding of material will change with the need of the user.
The staple is applied to bind two items together. A snap, jerk, or pull on one or both or the items causes the staple to break or separate in the weakened area.
Stapling devices with and without anvils may be used to bind items.
